(19) United States
(12) Patent Application Publication
(10) Pub. No.: US 2014/0059366 A1
(43) Pub. Date: Feb. 27, 2014

(54) ELECTRONIC DEVICE AND CONTROL METHOD

(71) Applicant: FUJITSU LIMITED, Kawasaki-shi (JP)

(72) Inventors: Koji MATSUSHITA, Kakogawa (JP); Takahide NORINOBU, Yokohama (JP); Susumu NIKAWA, Sagamihara (JP); Hitoshi NAKAMATA, Kawasaki (JP); Tomoharu KARIYA, Cyofu (JP); Toyohiro KATO, Kawasaki (JP)

(73) Assignee: FUJITSU LIMITED, Kawasaki-shi (JP)

(21) Appl. No.: 13/950,489

(22) Filed: Jul. 25, 2013

(30) Foreign Application Priority Data
Aug. 23, 2012 (JP) 2012-183921

(51) Int. Cl. G06F 1/32

(52) U.S. Cl. CPC G06F 1/3234
USPC 713/320

(57) ABSTRACT

An electronic device comprises a wireless unit, a control unit starting up the wireless unit at a predetermined startup time and a storage unit, wherein the wireless unit queries a wireless base station about a message and, when the message addressed to the electronic device exists, receives the message from the wireless base station, the control unit, when the message received by the wireless unit is an erase message, executes a process of erasing data stored in the storage unit, and the control unit, whereas when the message received by the wireless unit is not the erase message or when there is not the message addressed to the electronic device, stops the wireless unit.

### CROSS-REFERENCE TO RELATED APPLICATION

This application is based upon and claims the benefit of priority of the prior Japanese Patent Application No. 2012-183921 filed on Aug. 23, 2012, the entire contents of which are incorporated herein by reference.

### FIELD

The present invention relates to an electronic device, a control method and a program.

### BACKGROUND

A PC (Personal Computer), which supports a remote erase system, is requested to keep a power source of a wireless unit (wireless module) in an ON-status (startup status) at all times even in such a state that OS (Operating System) does not yet start up so that an erase instruction message can be always received. Further, the PC side is requested to set ON a power source of a WAKE signal receiving unit for receiving a WAKE signal emitted when the wireless unit receives the erase instruction message.

### DOCUMENT OF PRIOR ART

### Patent Document

[Patent document 1] Japanese Patent Application Laid-Open Publication No. 2008-90823

### SUMMARY

The remote erase system electrifies the wireless unit even in the status where the OS does not yet start up (shutdown status) and therefore rises in power consumption as compared with a PC that does not support a remote erase service. Moreover, in the remote erase system, when the PC exists out of a service area of the wireless base station, there increases a frequency at which the wireless module scans the wireless base station, and hence the power consumption rises as compared with a case where the PC exists in the service area of the wireless base station.

According to an aspect of the disclosure, an electronic device includes: a control unit; a wireless unit; and a storage unit, wherein the control unit starts up the wireless unit at a predetermined startup time, wherein the wireless unit queries a wireless base station about a message and, when the message addressed to the electronic device exists, receives the message from the wireless base station, wherein the control unit, when the message received by the wireless unit is an erase message, executes a process of erasing data stored in the storage unit, and wherein the control unit, whereas when the message received by the wireless unit is not the erase message or when there is not the message addressed to the electronic device, stops the wireless unit.

The aspect of the disclosure may be realized in such a way that an information processing apparatus executes a program. Namely, a configuration of the disclosure can be specified as a program for making the information processing apparatus execute processes carried out by respective means in the aspect described above or as a non-transitory computer-readable recording medium recorded with the program. Moreover, the configuration of the disclosure may also be specified as a method by which the information processing apparatus executes the processes carried out by the respective means.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating an example of a system architecture in an embodiment.

FIG. 2 is a diagram illustrating an example of the system architecture in an embodiment.

FIG. 3 is a diagram illustrating an example of a configuration of a PC in the embodiment.

FIG. 4 is a diagram illustrating an example (1) of an operation flow of a PC 100.

FIG. 5 is a diagram illustrating an example (2) of the operation flow of the PC 100.

FIG. 6 is a diagram illustrating an example (3) of the operation flow of the PC 100.

FIG. 7 is a diagram illustrating an example of time variations of power consumption of a wireless module 130 of the PC 100.

### DESCRIPTION OF EMBODIMENTS

An embodiment will hereinafter be described with reference to the drawings. A configuration of the embodiment is an exemplification, and a configuration of the disclosure is not limited to the specific configuration of the embodiment of the disclosure. On the occasion of implementing the configuration of the disclosure, a specific configuration corresponding to the embodiment may be properly adopted.

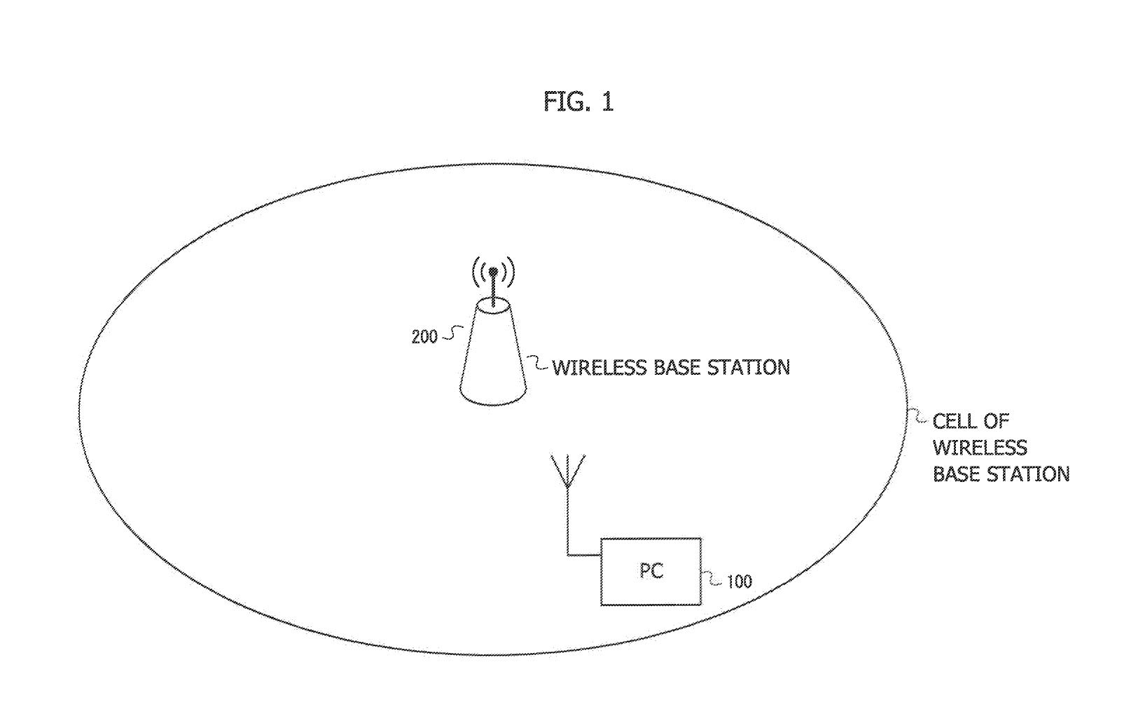

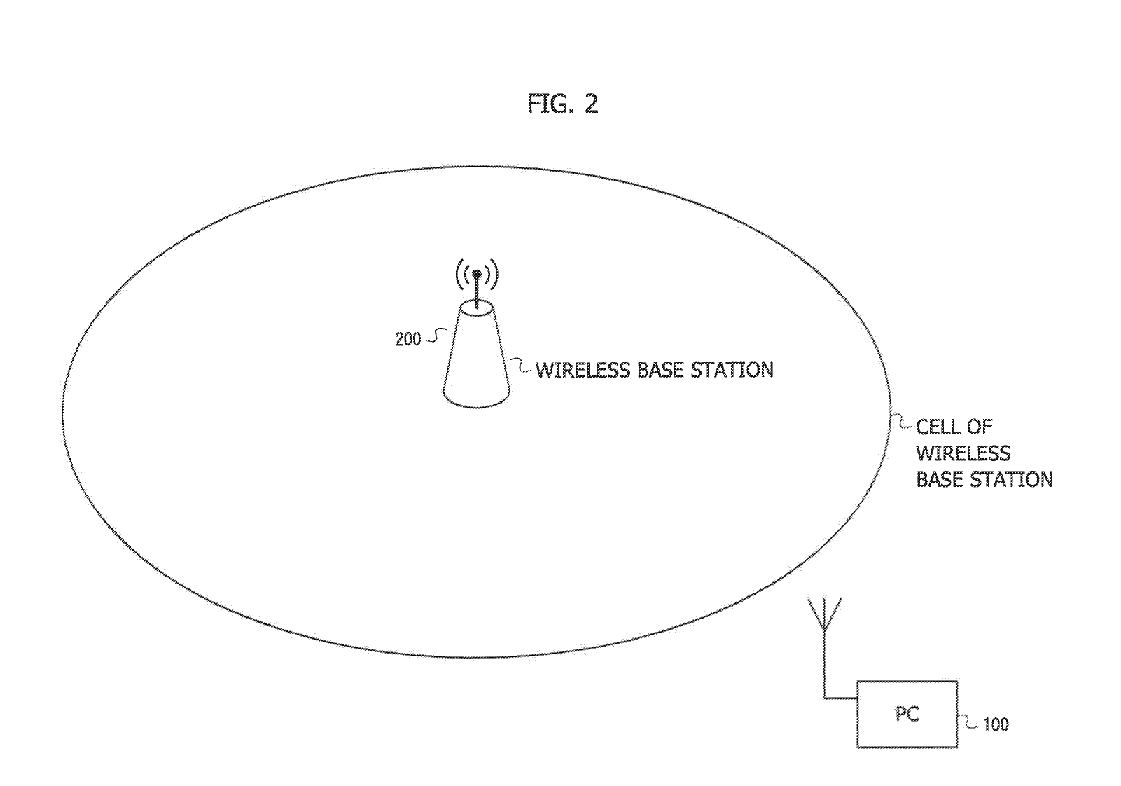

FIGS. 1 and 2 are diagrams each illustrating an example of a system architecture in the embodiment. The system in the embodiment includes a PC 100 and a wireless base station 200. Herein, a single wireless base station is provided, however, a plurality of wireless base stations may also exist. In the example of FIG. 1, the PC 100 exists in a cell of the wireless base station 200. At this time, the PC 100 can mutually perform communications with the wireless base station 200. The cell of the wireless base station 200 is an area in which the wireless base station can mutually perform the communications with a terminal device such as the PC. The cell of the wireless base station 200 is overlapped with a cell of another wireless base station as the case may be. In the example of FIG. 2, the PC 100 does not exist in the cell of the wireless base station 200. At this time, the PC 100 cannot mutually perform the communications with the wireless base station 200. As in FIG. 1, when the PC 100 exists in the cell of any one of the wireless base stations, it is said that the PC 100 is within a service area. Furthermore, as in FIG. 2, when the PC 100 does not exist in the cell of any wireless base station, it is said that the PC 100 is out of the service area.

The wireless base station 200 may be a base station of a mobile phone network, may also be a base station (access point) of a wireless LAN and may further be a base station of another wireless communication network.

### Example of Configuration

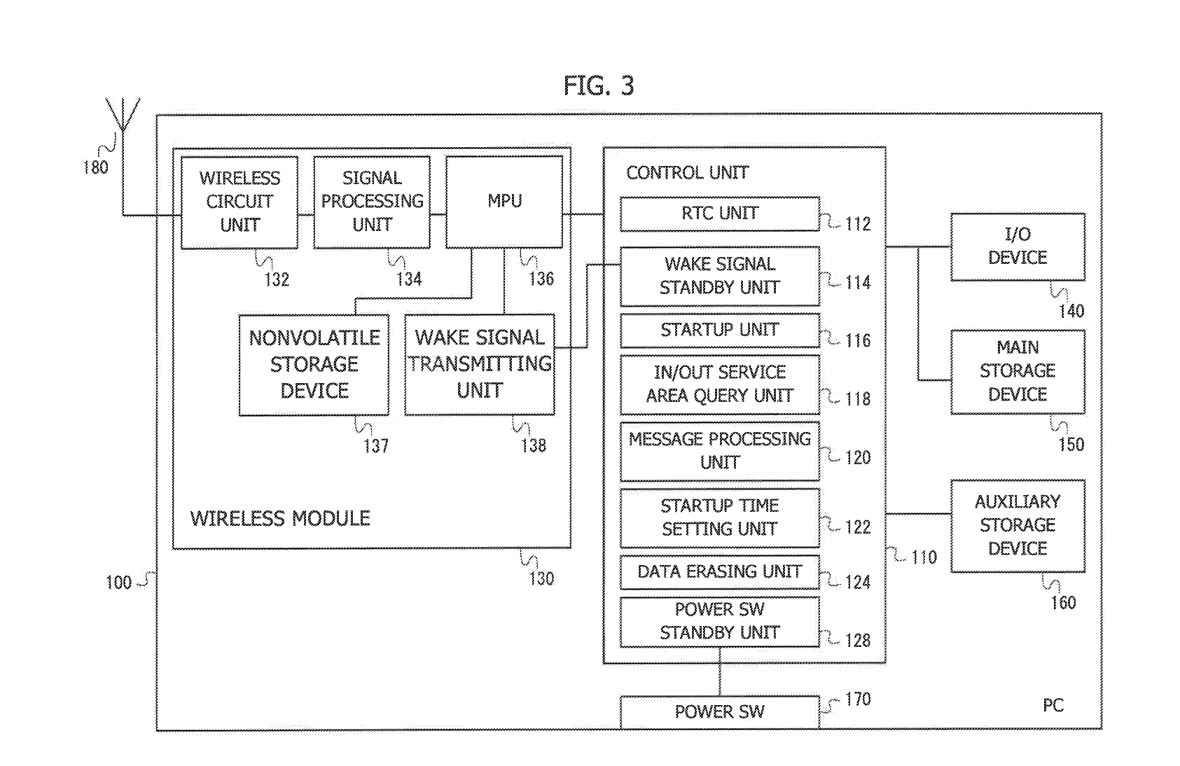

FIG. 3 is a diagram illustrating an example of a configuration of the PC in the embodiment. The PC (Personal Computer) 100 in FIG. 3 includes a control unit 110, a wireless module 130, an input/output (I/O) device 140, a main storage device (main memory) 150, an auxiliary storage device 160, a power SW (Switch) 170 and an antenna 180.

The PC 100 can be realized by use of an electronic device mounted with a computer. The PC 100 can be realized by employing a dedicated or general-purpose computer such as a portable PC, a desktop PC, a smartphone, a mobile phone and a car navigation system or by using an electronic device mounted with the computer. Further, the PC 100 can be also realized by using the general-purpose computer or a dedicated computer such as a server machine. The PC 100 can be also realized by employing a dedicated computer such as a workstation (WS) and a PDA (Personal Digital Assistant) or the general-purpose computer. The PC 100 is one example of an electronic device.

The control unit 110 includes an RTC (Real Time Clock) unit 112, a WAKE signal standby unit 114, a startup unit 116, an in/out service area query unit 118, a message processing unit 120, a startup time setting unit 122, a data erasing unit 124 and a power SW standby unit 128. The respective units included in the control unit 110 may be hardwarewise realized and may also be softwarewise realized.

The control unit 110 manages a status of the computer. The control unit 110 conducts transitions to a variety of statuses of the computer such as a startup status, a hibernating status and a shutdown status. Further, the control unit 110 has a function of accepting a power ON trigger from outside when in the hibernating status and the shutdown status. The control unit 110 has a function of accepting a forced power shutdown trigger when in the startup status.

The control unit 110 executes programs and manages the memory. The control unit 110 executes processes such as performing a variety of arithmetic operations, making calculations, processing images and displaying a browser in accordance with the programs and user's inputs. The control unit 110 deploys contents of the programs and the data onto the main storage device.

The control unit 110 executes a process of accepting inputs from a variety of input devices such as a keyboard and a pointing device. The control unit 110 outputs arithmetic results of the computer to output devices such as a display and a printer. The control unit 110 writes the data to the auxiliary storage device 160 or reads the data from the auxiliary storage device 160 in a way that corresponds to the program and the user's operation. The control unit 110 transfers and receives the data to and from other computers and communication stations via respective modules.

The RTC unit 112 is a clock of the computer and keeps counting the present time even in a power OFF-status of the computer. The RTC unit 112, when the present time reaches a predetermined startup time, instructs the startup unit 116 to start up the PC 100.

The WAKE signal standby unit 114 stands by for a WAKE signal of the wireless module 130 and the WAKE signal transmitted by the WAKE signal transmitting unit 138. The WAKE signal standby unit 114, upon receiving the WAKE signal, instructs the startup unit 116 to start up (wake up) the PC 100.

The startup unit 116 starts up the PC 100. The startup unit 116 sets the PC 100 in a startup status by starting up the I/O device 140, the main storage device 150, the auxiliary storage device 160 and the wireless module 130. The startup unit 116 sets, in an OFF-status (shutdown status), the I/O device 140, the main storage device 150, the auxiliary storage device 160 and the wireless module 130 by a softwarewise instruction based on a user's operation etc.

The in/out service area query unit 118 queries an MPU 136 of the wireless module 130 about whether the PC 100 exists in or out of a service area of the wireless base station.

The message processing unit 120 queries the MPU 136 of the wireless module 130 about whether the wireless module 130 receives a message from the wireless base station or not. The message processing unit 120, when the wireless module 130 receives the message, downloads this message. The message is, e.g., a message based on SMS (Short Message Service).

The startup time setting unit 122 sets next the time when starting up the PC 100. The startup time setting unit 122, when starting up next the time, instructs the startup unit 116 to set the PC 100 in the OFF-status.

The data erasing unit 124 executes an erasing process with respect to the auxiliary storage device 160. The data erasing unit 124 erases, as the erasing process, all the data stored in the auxiliary storage device 160. Further, the data erasing unit 124 may delete, as the erasing process, a decryption key for decrypting the encrypted data in the auxiliary storage device 160.

The power SW standby unit 128 stands by for notification of a status of the power SW from a power SW 170. The power SW standby unit 128 sets ON or OFF the power source of the PC 100 depending on the status of the power SW 170. The power SW standby unit 128, when notified of “ON” as the status of the power SW 170, instructs the startup unit 116 to start up the PC 100.

In the respective processing units in the control unit 110, an arbitrary single processing unit may operate as a plurality of processing units. Further, in the respective processing units in the control unit 110, arbitrary two or more single processing units may operate as a single processing unit. Still further, in the respective processing units in the control unit 110, a part of the whole of two or more single processing units or the whole of the processing units may operate as a single processing unit.

The wireless module 130 includes a wireless circuit unit 132, a signal processing unit 134, an MPU (Micro Processing Unit) 136, a nonvolatile storage device 137, a WAKE signal transmitting unit 138.

The wireless circuit unit 132 supplies the electricity to the antenna 180. The wireless circuit unit 132 executes a process such as demodulating the reception signal. The wireless circuit unit 132 executes a process such as modulating the transmission signal.

The signal processing unit 134 converts a digital signal into an analog transmission signal. The signal processing unit 134 converts an analog reception signal into the digital signal.

The MPU 136 controls the wireless module 130. The MPU 136 stores the received message in the nonvolatile storage device 137.

The nonvolatile storage device 137 gets stored with the message received from the wireless base station 200. The message stored in the nonvolatile storage device 137 is read in response to a request given from the control unit 110.

The WAKE signal transmitting unit 138 transmits the WAKE signal to the WAKE signal standby unit 114 in the control unit 110.

The I/O device 140 includes an input device such as the keyboard and the pointing device and an output device such as the display device and the printer. Further, the input device can include a video/image input device such as a camera and a voice input device such as a microphone. Moreover, the output device can include a voice input device such as a loudspeaker.

The main storage device 150 includes, e.g., a RAM (Random Access Memory) and a ROM (Read Only Memory). The programs and the data used by the control unit 110 are deployed on the main storage device 150.

The auxiliary storage device 160 is stored with the programs and the data used in the programs. The auxiliary storage device 160 is exemplified such as an EPROM (Erasable Programmable ROM), a hard disk drive (HDD) and a sold-state drive (SSD). Further, the auxiliary storage device 160 can include removable mediums, i.e., portable recording mediums. The removable mediums are disk recording mediums such as a USB (Universal Serial Bus) memory, or a CD (Compact Disc) and a DVD (Digital Versatile Disc).

The power SW 170 is a hardware switch operated by the user. The user operates the power SW 170 to set ON or OFF the power source of the PC 100. The power SW standby unit 128 in the control unit 110 is notified of the status of the power SW 170.

The antenna 180 transmits and receives the radio signals to and from the wireless base station. In the PC 100, the smaller the number of the units operating underway is, the lower the power consumption becomes.

The computer, i.e., an information processing apparatus, includes a processor, a main storage device (main memory), an auxiliary storage device and interface devices such as communication interface devices with peripheral devices. The main storage device and the auxiliary storage device are non-transitory computer-readable recording mediums.

The computer can, with the processor loading the programs stored on recording medium into an operation area on the main storage device and executing the programs and with the peripheral devices being controlled through executing the programs, realize functions conforming to predetermined purposes. The processor is exemplified such as a CPU (Central Processing Unit) and a DSP (Digital Signal Processor).

The computer realizing the PC 100 actualizes, with the processor loading the programs stored in the auxiliary storage device into the main storage device and executing the programs, the functions as the respective units in the control unit 110.

The respective units in the control unit 110 can be individually realized as hardware components and software components or as combinations thereof.

the hardware components are hardware circuits that are exemplified by an FPGA (Field Programmable Gate Array), an ASIC (Application Specific Integrated Circuit), a gate array, a combination of logic gates, analog circuits, etc.

The software components are components that realize softwarewise predetermined processes. The software component is not a concept that limits a program language etc for realizing the software.

Steps for describing the program include, as a matter of course, processes executed in time-series along the sequence described therein and also processes executed, though not necessarily processed in time-series, in parallel or individually.

Herein, the instruction of erasing the data via the erase message is exemplified as the instruction given from the wireless base station (or a host device above the wireless base station), however, the instruction given from the wireless base station etc may also be an instruction other than the data erase instruction.

### Operational Example

An operational example of the PC 100 in the embodiment will be described. An initial status is assumed to be such that all the components of the PC 100 in FIG. 3 will have been started up.

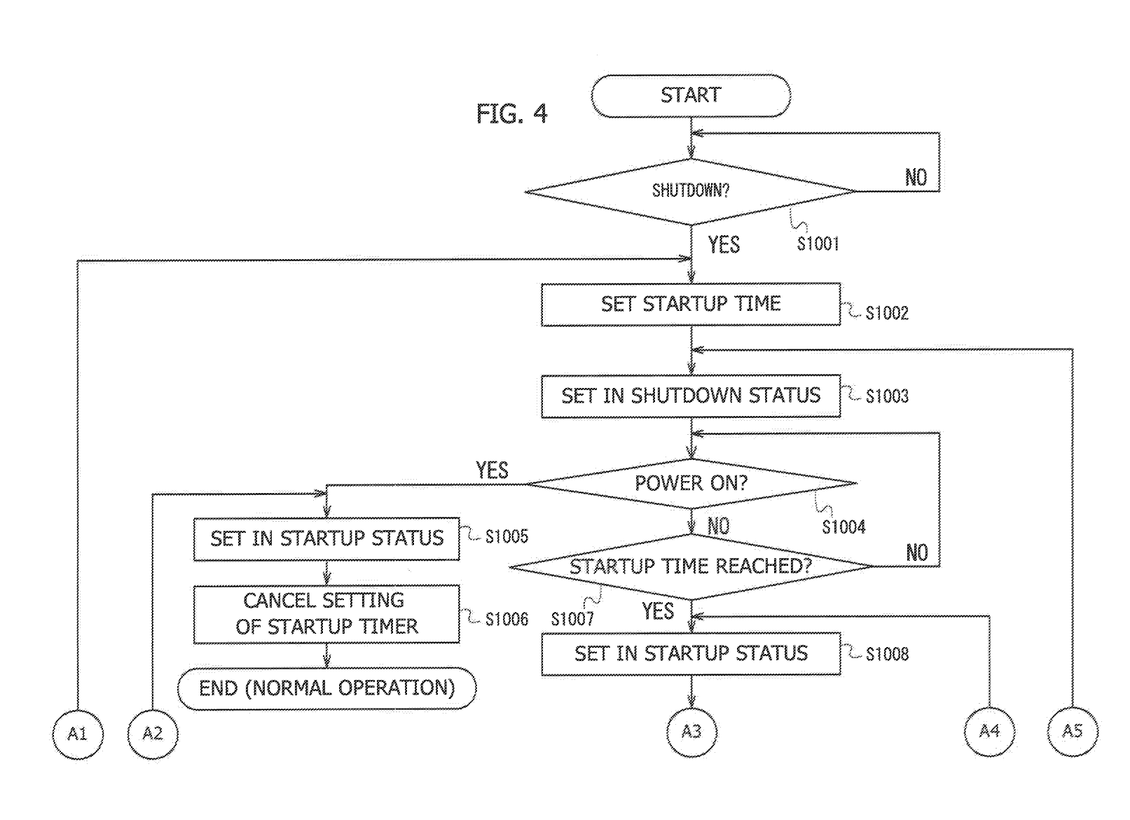

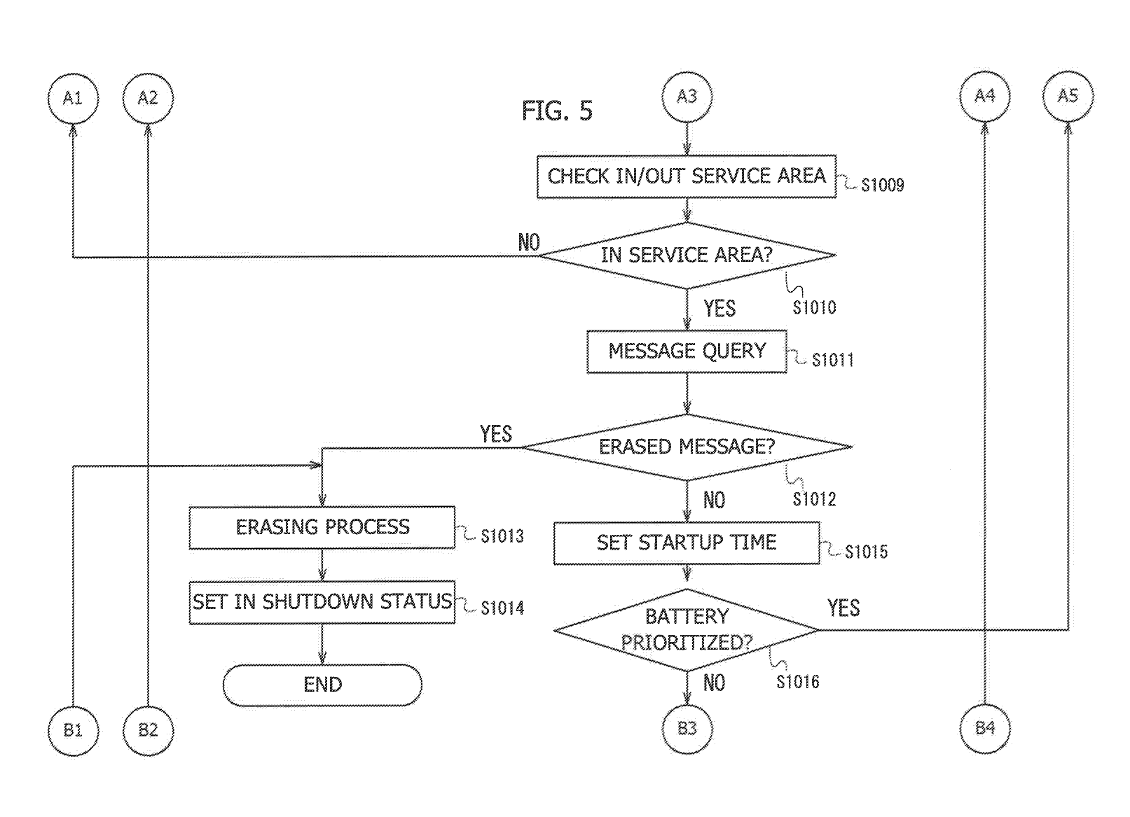

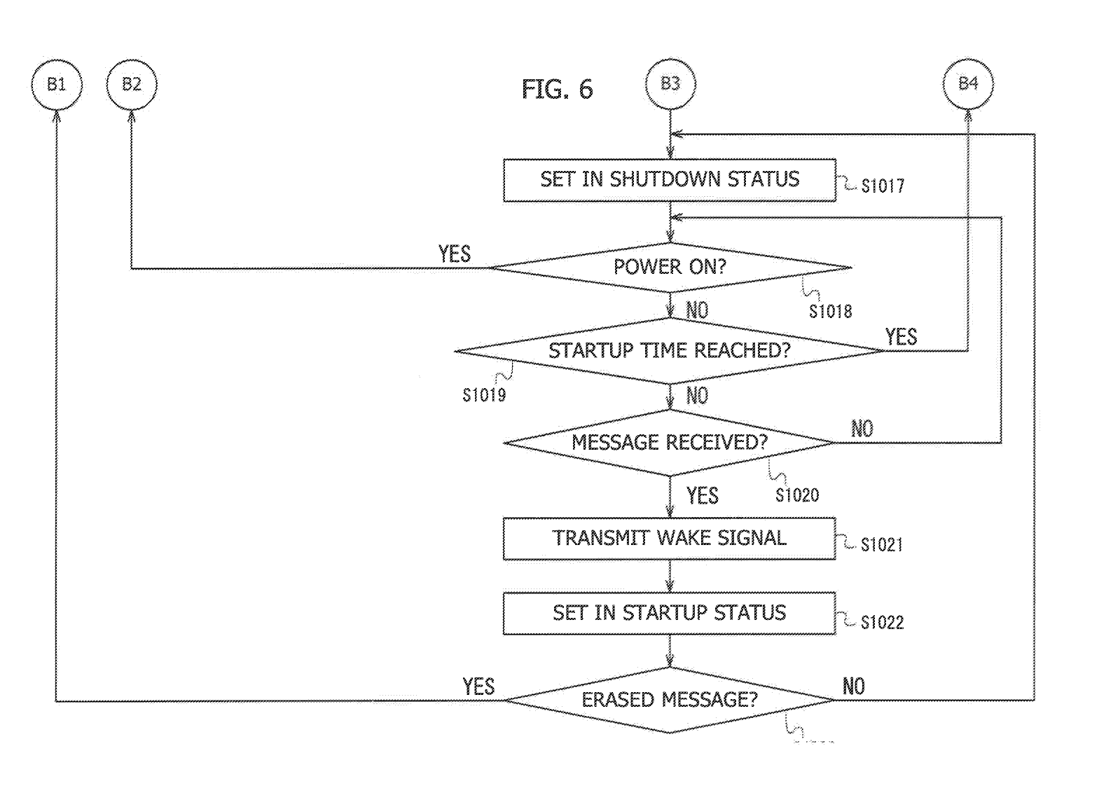

FIGS. 4, 5 and 6 are diagrams each illustrating an example of an operation flow of the PC 100. Symbols [A1], [A2], [A3], [A4] and [A5] in FIG. 4 are connected to [A1], [A2], [A3], [A4] and [A5] in FIG. 5, respectively. Symbols [B1], [B2], [B3] and [B4] in FIG. 5 are connected to [B1], [B2], [B3] and [B4] in FIG. 6, respectively.

The startup unit 116 in the control unit 110 of the PC 100 determines whether or not a shutdown instruction is given softwarewise based on the user's operation etc (S1001). The startup unit 116 stands by till the shutdown instruction is given (S1001; NO). When the shutdown instruction is given (S1001; YES), the startup unit 116 notifies the startup time setting unit 122 of the shutdown instruction.

In step S1002, the startup time setting unit 122 sets the time when started up next. The next startup time may be the time after an elapse of a predetermined period of time from the present time and may also be the most immediate time in one or more predetermined points of time. The present time is counted by the RTC unit 112.

In step S1003, the startup unit 116 in the control unit 110 sets the PC 100 in the shutdown status (OFF-status). Herein, the startup unit 116 sets the wireless module 130, the I/O device 140, the main storage device 150 and the auxiliary storage device 160 in the shutdown status (OFF-status). Moreover, the startup unit 116 sets, in the OFF-status, the processing units other than the RTC unit 112 and the power SW standby unit 128 in the control unit 110 and terminates its processing. Herein, the units other than the RTC unit 112 and the power SW standby unit 128 in the control unit 110 are in the OFF-status. In the OFF-status, the electric power is hardly consumed.

The power SW standby unit 128 stands by for the notification of the status of the power SW from the power SW 170 (S1004). The power SW 170 is set in the ON-status by the user's operation. The power SW standby unit 128, when receiving the notification that the status of the power SW 170 is the ON-status (S1004; YES), starts up the startup unit 116 and instructs the startup unit 116 to start up the PC 100.

In step S1005, the startup unit 116 starts up the wireless module 130, the I/O device 140, the main storage device 150 and the auxiliary storage device 160, which are kept in the OFF-status so far. Further, the startup unit 116 starts up the respective OFF-status processing units in the control unit 110. Moreover, the startup time setting unit 122 cancels the setting of the startup time set on the occasion of the shutdown (S1006). Through these processes, the operation of the operation flow is finished, and the PC 100 shifts to the normal operation.

Whereas when not receiving the notification that the status of the power SW 170 is the ON-status (S1004; NO), the RTC unit 112 determines whether the present time reaches the startup time set by the startup time setting unit 122 or not (S1007). When the present time does not reach the startup time set by the startup time setting unit 122 (S1007; NO), the processing loops back to step S1004. Whereas when the present time reaches the startup time set by the startup time setting unit 122 (S1007; YES), the RTC unit 112 starts up the startup unit 116, and the processing proceeds to step S1008.

In step S1008, the startup unit 116 starts up the wireless module 130, the I/O device 140, the main storage device 150 and the auxiliary storage device 160, which are kept in the OFF-status so far. Further, the startup unit 116 starts up the respective OFF-status processing units in the control unit 110.

The in/out service area query unit 118 checks whether the PC 100 exists in or out of the service area of the cell of the wireless base station 200 (S1009). The in/out service area query unit 118 instructs the MPU 136 of the wireless module 130 to make a query about an attachment state to the wireless base station 200. The terms “attachment” implies that the mobile terminal captures the wireless base station and becomes a connectable status. The MPU 136 of the wireless module 130 checks whether or not the PC 100 attaches to the wireless base station 200 via the signal processing unit 134, the wireless circuit unit 132 and the antenna 180. The check as to whether attached or not can be done depending on, e.g., whether the signals can be transmitted and received between the PC 100 and the wireless base station 200. The MPU 136 transmits the information about being or not being attached to the in/out service area query unit 118 in the control unit 110.

The in/out service area query unit 118 determines, based on the information given from the MPU 136 whether the PC 100 exists in or out of the service area of the cell of the wireless base station 200 (S1010). When determining that the PC 100 exists out of the service area of the cell of the wireless base station 200 (S1010; NO), the processing loops back to step S1002.

Whereas when determining that the PC 100 exists in the service area of the cell of the wireless base station 200 (S1010; YES), the in/out service area query unit 118 notifies the message processing unit 120 that the PC is in the service area. The message processing unit 120 receiving the notification instructs the MPU 136 of the wireless module 130 to make a message query (S1011). The MPU 136 receiving the instruction queries the wireless base station 200 about whether or not there is a message addressed to the PC 100 via the signal processing unit 134, the wireless circuit unit 132 and the antenna 180. The wireless base station 200 (or the host device above the wireless base station 200) transmits the message to the PC 100 when having the message addressed to the PC 100. The message transmitted from the side of the wireless base station 200 is received by the MPU 136 via the antenna 180, the wireless circuit unit 132 and the signal processing unit 134. The MPU 136 stores the received message in the nonvolatile storage device 137. The message processing unit 120 requests the MPU 136 for the message received by the MPU 136. The MPU 136 reads the message received from the nonvolatile storage device 137 and transmits the message to the message processing unit 120. When there is a plurality of received messages, the MPU 136 transmits all the received messages to the message processing unit 120.

The message processing unit 120 determines whether an erase message exists in the messages received from the MPU 136 or not (S1012). The erase message is a message for giving an instruction to erase the data stored in the auxiliary storage device 160 of the PC 100.

When the erase message is contained in the messages received from the MPU 136 (S1012; YES), the message processing unit 120 instructs the data erasing unit 124 to erase the data stored in the auxiliary storage device 160. The data erasing unit 124 given the infraction from the message processing unit 120 executes the erasing process with respect to the auxiliary storage device 160 (S1013). The data erasing unit 124 erases, as the erasing process, all the data stored in the auxiliary storage device 160. Further, the data erasing unit 124 may delete, as the erasing process, the decryption key for decrypting the encrypted data in the auxiliary storage device 160. The process by the data erasing unit 124 disables the data stored in the auxiliary storage device 160 from being read.

When the data erasing unit 124 finishes erasing the data, the startup unit 116 sets the PC 100 in the shutdown status (S1014). Herein, the startup unit 116 sets the wireless module 130, the I/O device 140, the main storage device 150 and the auxiliary storage device 160 in the shutdown status. Further, the startup unit 116 sets, in the OFF-status, the processing units other than the RTC unit 112, the WAKE signal standby unit 114 and the power SW standby unit 128 of the control unit 110, and terminates its processing. When the energy of the battery is all consumed up as kept in the startup status, the PC 100 might be damaged. The damage to the PC 100 can be restrained by setting in the shutdown status.

Whereas when the erase message is not contained in the messages received from the MPU 136 (S1012; NO), the message processing unit 120 instructs the startup time setting unit 122 to set the startup time. The startup time setting unit 122 set the next startup time (S1015). The operation in this step S1015 is the same as the operation in step S1002.

The startup unit 116 determines whether the setting of the PC 100 is a “battery prioritized mode” or an “erase message reception prioritized mode” (S1016). Information of the setting of the “battery prioritized mode” or the “erase message reception prioritized mode” is previously stored in the main storage device 150 or the auxiliary storage device 160. The startup unit 116 can determine from the information stored in the main storage device 150 or the auxiliary storage device 160 whether the setting of the PC 100 is the “battery prioritized mode” or the “erase message reception prioritized mode”.

The “battery prioritized mode” is a mode for increasing a life-time of the battery for a longer period of time by reducing the power consumption the greatest possible degree. The “erase message reception prioritized mode” is a mode for enabling the erase message to be received without any delay.

When the setting of the PC 100 is the “battery prioritized mode” (S1016; YES), the processing loops back to S1003.

When the setting of the PC 100 is the “erase message reception prioritized mode” (S1016; NO), the startup unit 116 sets the PC 100 in the shutdown status (OFF-status). Herein, the startup unit 116 sets the I/O device 140, the main storage device 150 and the auxiliary storage device 160 in the shutdown status. The wireless module 130 is herein in the startup status (ON-status). Moreover, the startup unit 116 sets, in the OFF-status, the processing units other than the RTC unit 112, the WAKE signal standby unit 114 and the power SW standby unit 128 in the control unit 110, and terminates its processing.

In step S1018, the power SW standby unit 128 stands by for the notification of the status of the power SW from the power SW 170. The power SW 170 is set in the ON-status by the user's operation. When receiving the notification that the status of the power SW 170 is the ON-status (S1018; YES), the startup unit 116 is started up, and the power SW standby unit 128 instructs the startup unit 116 to start up the PC 100, and the processing proceeds to step S1005.

When not receiving the notification that the status of the power SW 170 is the ON-status (S1018; NO), the RTC unit 112 determines whether or not the present time reaches the startup time set by the startup time setting unit 122 (S1019). When the present time reaches the startup time set by the startup time setting unit 122 (S1019; YES), the RTC unit 112 starts up the startup unit 116, and the processing loops back to step S1008. Whereas when the present time does not reach the startup time set by the startup time setting unit 122 (S1019; NO), the processing proceeds to step S1020.

The wireless module 130 is not set in the shutdown status in step S1017 and therefore remains in the startup status also in step S1020. Further, the wireless module 130 remains in the startup status, and hence, when the PC 100 exists in the service area of the wireless base station 200, the connection status with the wireless base station 200 is kept. The wireless base station 200, when in the connection status with the PC 100 and when receiving the message addressed to the PC 100, transmits this message to the PC 100. Accordingly, the wireless module 130 can receive the message. The MPU 136 of the wireless module 130, when the message is transmitted from the wireless base station 200, receives the message via the antenna 180, the wireless circuit unit 132 and the signal processing unit 134. The MPU 136 stores the received message in the nonvolatile storage device 137.

In step S1020, the MPU 136 checks whether the message is received or not. When the MPU 136 does not receive the message (S1020; NO), the processing loops back to step S1018.

When the MPU 136 receives the message (S1020; YES), the WAKE signal transmitting unit 138 of the wireless module 130 transmits the WAKE signal to the WAKE signal standby unit 114 in the control unit 110 (S1021). The WAKE signal standby unit 114, upon receiving the WAKE signal, starts up the startup unit 116.

In step S1022, the startup unit 116 starts up the I/O device 140, the main storage device 150 and the auxiliary storage device 160, which are kept in the OFF-status so far. Further, the startup unit 116 starts up the respective OFF-status processing units in the control unit 110.

The message processing unit 120 requests the MPU 136 for the message received by the MPU 136. The MPU 136 reads the message received from the nonvolatile storage device 137 and transmits the message to the message processing unit 120. When there is a plurality of received messages, the MPU 136 transmits all the received messages to the message processing unit 120.

It is determined whether the erase message exists in the messages received from the MPU 136 or not (S1023). When the erase message is contained in the messages received from the MPU 136 (S1023; YES), the message processing unit 120 instructs the data erasing unit 124 to erase the data stored in the auxiliary storage device 160. The processing proceeds to step S1013.

Whereas when the erase message is not contained in the messages received from the MPU 136 (S1023; NO), the processing loops back to step S1017.

The PC 100 may not execute the processes from step S1017 through step S1023 without adopting the “erase message reception prioritized mode.” Namely, the routine may be contrived to select only “YES” in step S1016. At this time, the PC 100 may not include the WAKE signal standby unit 114 of the control unit 110 and the WAKE signal transmitting unit 138 of the wireless module 130. The configuration of the PC 100 is simplified by omitting the WAKE signal standby unit 114 of the control unit 110 and the WAKE signal transmitting unit 138 of the wireless module 130.

### Operation and Effect of Embodiment

The PC 100, which can accept the message-based instruction from outside, sets the wireless module 130 in the shutdown status after being shut down by the user's operation etc. The PC 100, when reaching the startup time, sets the whole PC 100 including the wireless module 130 in the startup status, and receives the message from the wireless base station 200. The PC 100, when receiving the message containing the instruction message such the error message from the wireless base station 200, executes the process based on this instruction. Moreover, the PC 100, when not receiving the message containing the instruction message such as the error message, sets the PC 100 itself in the shutdown status till the next startup time. The PC 100 sets the wireless module in the shutdown status and can thereby reduce the power consumption of the wireless module as compared with the system keeping the wireless module in the startup status. Further, in the system keeping the wireless module in the startup status, when the terminal exists out of the service area of the cell of the wireless base station, it follows that a greater amount of power is consumed. The PC 100, even when existing out of the service area of the cell of the wireless base station, sets the wireless module in the shutdown status and can therefore reduce the power consumption of the wireless module as compared with the system keeping the wireless module in the startup status. When in the shutdown status, the PC 100, with only the RTC unit 112 etc operating, can restrain the power consumption of the PC 100 itself down to a low level while maintaining the remote erase function.

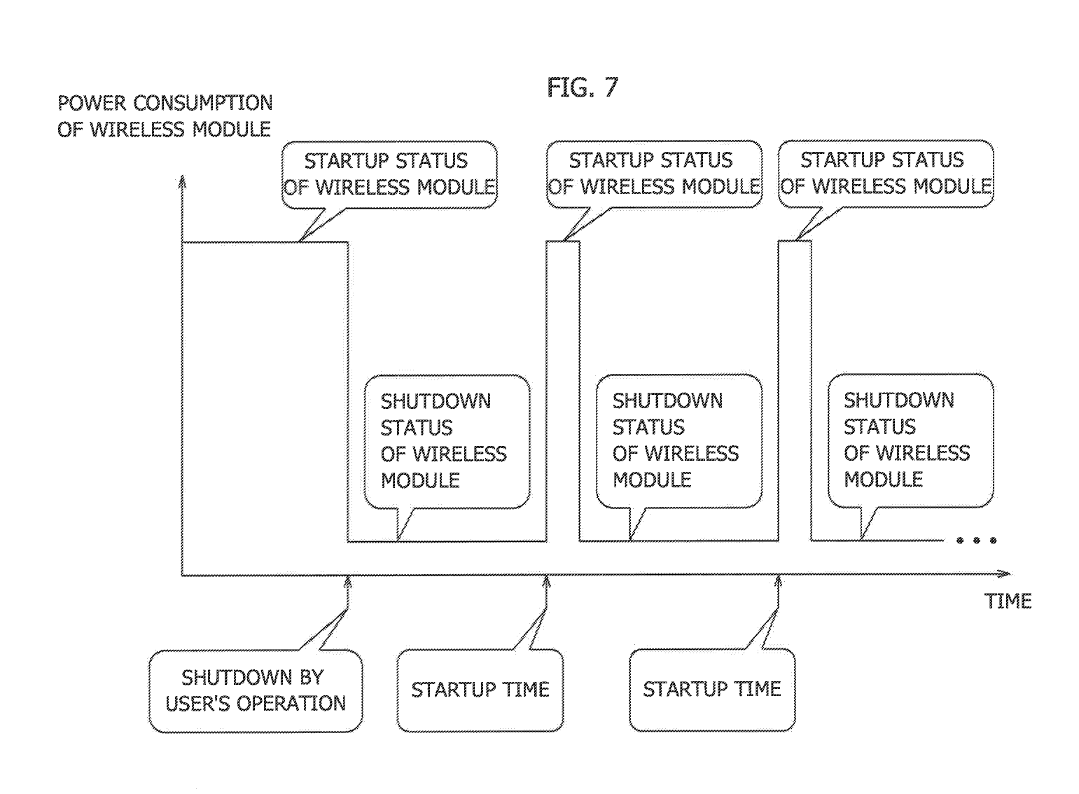

FIG. 7 is a diagram illustrating an example of time variations of the power consumption of the wireless module 130 of the PC 100. The axis abscissa of a graph in FIG. 7 indicates the time, while the axis of ordinate indicates the power consumption of the wireless module. In the example of FIG. 7, after shutting down the PC 100 by the user's operation etc, the wireless module comes to the shutdown status, with the result that the power consumption of the wireless module 130 decreases. The PC 100, when reaching the startup time, sets the wireless module 130 in the startup status, resulting in an increase in power consumption. The PC 100, however, determines whether or not the PC 100 itself exists in the service area of the wireless base station 200, and, when giving the message query to the wireless base station 200, sets the wireless module 130 in the shutdown status till the next startup time (the case of “battery prioritized mode”). The PC 100, after the PC 100 has been shut down by the user's operation etc, sets the wireless module 130 in the shutdown status in the great majority of time. Accordingly, the PC 100 can reduce the power consumption of the wireless module as compared with the system keeping the wireless module in the startup status. Namely, the PC 100 can reduce the power consumption of the PC 100 as a whole after being shut down by the user's operation. Moreover, the PC 100 receives the message upon starting up at the startup time and can thereby receive the instruction message such as the erase message.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An electronic device comprising:
a wireless unit;
a control unit starting up the wireless unit at a predetermined startup time; and
a storage unit,
wherein the wireless unit queries a wireless base station about a message and, when the message addressed to the electronic device exists, receives the message from the wireless base station,
the control unit, when the message received by the wireless unit is an erase message, executes a process of erasing data stored in the storage unit, and
the control unit, whereas when the message received by the wireless unit is not the erase message or when there is not the message addressed to the electronic device, stops the wireless unit.

2. The electronic device according to claim 1, wherein the wireless unit determines whether or not the electronic device exists in a service area of a cell of the wireless base station, and
the control unit, when the electronic device exists out of the service area of the cell of the wireless base station, stops the wireless unit and sets the startup time of the wireless unit at the next time.

3. A control method by which an electronic device including a wireless unit and a storage unit executes:
starting up the wireless unit at a predetermined startup time;
querying a wireless base station about a message and, when the message addressed to the electronic device exists, receiving the message from the wireless base station;
executing, when the message received by the wireless unit is an erase message, a process of erasing data stored in the storage unit, and
stopping the wireless unit whereas when the message received by the wireless unit is not the erase message or when there is not the message addressed to the electronic device.

4. The control method according to claim 3, wherein the electronic device determines whether or not the electronic device exists in a service area of a cell of the wireless base station, and
the electronic device, when the electronic device exists out of the service area of the cell of the wireless base station, stops the wireless unit and sets the startup time of the wireless unit at the next time.

5. A non-transitory computer readable medium recorded with a program to make an electronic device including a wireless unit and a storage unit execute:
starting up the wireless unit at a predetermined startup time;
querying a wireless base station about a message and, when the message addressed to the electronic device exists, receiving the message from the wireless base station;
executing, when the message received by the wireless unit is an erase message, a process of erasing data stored in the storage unit, and
stopping the wireless unit whereas when the message received by the wireless unit is not the erase message or when there is not the message addressed to the electronic device.

6. The non-transitory computer readable medium recorded with the program according to claim 5, wherein the program to make the electronic device further execute:
making the electronic device execute determining whether or not the electronic device itself exists in a service area of a cell of the wireless base station; and
stopping the wireless unit and setting the startup time of the wireless unit at the next time when the electronic device exists out of the service area of the cell of the wireless base station.
